(19) United States
(12) Patent Application Publication
(10) Pub. No.: US 2006/0030644 A1
(43) Pub. Date: Feb. 9, 2006

(54) Mattress with side panel of enhanced flammability resistance

(76) Inventors: George Hairston, Spartanburg, SC (US); John Burns, Simpsonville, SC (US); Warren Stidham, Cohutta, GA (US); Kim Van Voorhis, Rutherfordton, NC (US)

Correspondence Address: James M. Robertson;J.M. Robertson IP Services, LLC, 233 S. Pine Street, Spartanburg, SC, 29302, US

(21) Appl. No.: 11/040,353

(22) Filed: Jan. 21, 2005

Related U.S. Application Data
(63) Continuation-in-part of application No. 10/912,868, filed on Aug. 6, 2004.

(51) Int. Cl. C08K 5/34; C08K 5/05

(52) U.S. Cl. 524/100; 524/387

(57) ABSTRACT

A mattress including a side surface panel structure incorporating a fibrous textile layer treated with intumescent flame retardant composition to provide substantially improved flame resistance. The fibrous textile layer is free from brominated compounds and retains pliability.

### CROSS-REFERENCE TO RELATED APPLICATIONS

This application is a continuation-in-part of prior copending application Ser. No. 10/912,868 filed 6 Aug. 2004 the contents of which are incorporated herein by reference in their entirety.

### TECHNICAL FIELD

This invention relates generally to residential and commercial mattresses and more particularly to mattress side panels that incorporate textile materials imparting enhanced resistance to flammability.

### BACKGROUND OF THE INVENTION

In a number of environments it is desirable for textile components to have a degree of flame resistance. One environment of textile use where flame resistance is desirable is as side panels for residential or commercial mattresses.

In the past, flame resistance has typically been achieved in textiles by use of synthetic flame retardant refractory fiber constituents such as asbestos, metal oxides and the like and/or by application of chemical flame resisting saturating chemical agents. While such practices have permitted the production of products having a relatively high degree of flame resistance, the practices have been relatively complex and costly to carry out. Moreover, such flame resistant fiber materials and chemical treatments may cause undesirable reactions in some users.

Intumescent compositions, which react on contact to flame by charring and swelling, are known. When such compositions are subjected to flame, charring and swelling occurs forming layers which may be filled with non-flammable gasses created during the intumescent reaction. The layers so formed thus provide a degree of insulation against continued combustion. Typical applications for such intumescent compositions have included building material and paints to prevent the spread of fire and structural damage.

It has also been proposed to use intumescent coatings across substrates such as fabrics to provide a degree of thermal protection to the substrates. By way of example only, such uses are described in U.S. patent application U.S. 2003/0082972 A1 in the name of Monfalcone III et. al. the contents of which are hereby incorporated by reference as if fully set forth herein. As best understood, the flame retardant compositions which have been utilized in the past have been standard commercial intumescent compositions. While such compositions may provide enhanced levels of flame resistance, it is believed that such traditional compositions may in some instances also provide enhanced levels of stiffness to the fabric or other substrate.

Testing procedures which are believed to be appropriate for evaluating the flame resistance of a residential or commercial mattress are set forth in California Bureau of Home Furnishings and: Thermal Insulation Technical Bulletin 603 (hereinafter “Technical Bulletin 603”), the contents of which will be well known to those of skill in the art and which are hereby incorporated by reference as if fully set forth herein.

In the testing procedure of Technical Bulletin 603 a pair of propane burners are utilized to mimic the heat flux levels and durations imposed on a mattress and foundation by burning bedclothes. These burners impose differing fluxes for differing times on the mattress top and on the sides of the mattress and any underlying foundation. The resulting smoke plume is captured and heat release levels are measured by oxygen consumption calorimetry using instrumentation as set forth in ASTM E 1590 (incorporated by reference): The test method also provides a measure of the emissions of carbon monoxide and carbon dioxide.

In the test of Technical Bulletin 603, propane gas from a source such as a bottle having a net heat of combustion of 46.5±0.5 MJ/kg (nominally 99% to 100% propane) is delivered through a multi-orifice stainless steel manifold burner having 34 openings (17 on each side of a T junction with the gas inlet) arranged to impact the top of the mattress. Propane is simultaneously delivered through a similar manifold burner having 28 openings (14 on each side of a T junction with the gas inlet) arranged to impact the sides the mattress/foundation. The openings in the burners are drilled using a #56 drill and are 1.17 mm to 1.22 mm in diameter. The gas flow rate to the top burner is 12.9±0.1 L/min at a pressure of 101±5 kPa (standard atmospheric pressure) and a temperature of 22±3 degrees Celsius corresponding to a flow rate of about 0.38 L/min per opening. The gas flow rate to the side burner is 6.6±0.5 L/min at a pressure of 101±5 kPa (standard atmospheric pressure) and a temperature of 22±3 degrees Celsius corresponding to a flow rate of about 0.24 L/min per opening. The duration of gas flow is 70 seconds for the top burner and 50 seconds for the side burner. Under the testing criteria of Technical Bulletin 603, a mattress or a mattress/box spring set is considered to pass if the maximum rate of heat release is less than 150 kW and the total heat release is less than 25 MJ in the first 10 minutes of the test. Duration of the test is 30 minutes total.

### SUMMARY OF THE INVENTION

The present invention provides advantages and alternatives over the prior art by providing a side panel for a mattress including a fibrous textile treated with intumescent flame retardant compositions to provide substantially improved flame resistance. The invention achieves the goal of enhanced fire retardancy without using brominated compounds such as decabromines, octabromines, pentabromines and their derivatives which may be undesirable to some users. Moreover, the present invention does not require substantial percentages of fiberglass, toxic substances, skin irritants, or other materials that may present disposal issues or which otherwise may not be not be environmentally friendly.

### BRIEF DESCRIPTION OF THE DRAWINGS

The following drawings which are incorporated in and which constitute a part of this specification illustrate various exemplary embodiments and practices according to the present invention and, together with the general description above and the detailed description set forth below, serve to explain the principles of the invention wherein:

FIG. 1 is a perspective view of a mattress and box spring set incorporating a textile surface side panel;

FIG 1A is a cross-sectional view through an exemplary mattress side panel;

FIG. 2A is a simplified illustration of a processing line for applying a topical coating treatment of flame retardant composition to a textile substrate for use in a side panel for a mattress; and

FIG. 2B is a simplified illustration of a processing line for applying an infused treatment of flame retardant composition to a textile substrate for use in a side panel for a mattress.

While the present invention has been generally described above and will hereinafter be described through reference to the drawings in connection with certain potentially preferred embodiments, procedures and practices, it is to be understood that in no case is the invention to be limited to such illustrated and described embodiments, procedures and practices. On the contrary, it is intended that the present invention shall extend to all alternatives, modifications, and equivalents as may embrace the principles of the present invention within the true scope and spirit thereof.

### DESCRIPTION OF PREFERRED EMBODIMENTS

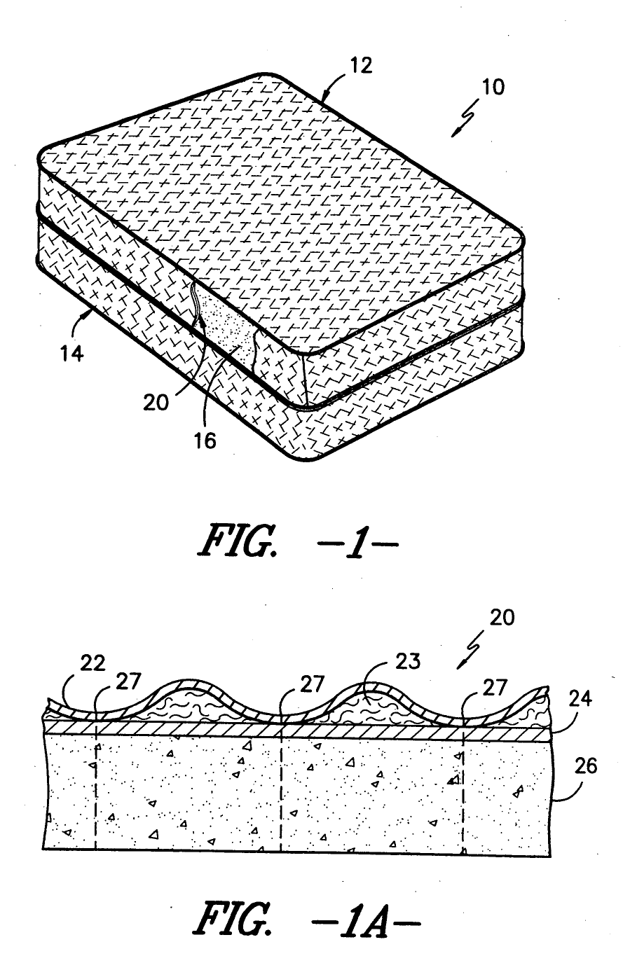

Reference will now be made to the various drawings wherein to the extent possible like reference numerals are utilized to designate corresponding components throughout the various views. In FIG. 1 there is illustrated a mattress and box spring set 10, including a mattress 12 and an underlying supporting box spring 14. As will be appreciated, the mattress 12 generally includes a core 16 of springs (not shown) surrounded by foam.

In the illustrated arrangement the core 16 is covered across a side surface by a side panel 20 which includes at least one layer of fibrous textile material treated with an intumescent flame retardant composition as will be described more fully hereinafter. As will be appreciated, by the term “side surface” is meant a surface disposed along the lateral sides or ends of the mattress normally positioned in a substantially vertical orientation when the mattress is in use.

It is contemplated that the intumescent flame retardant composition may be coated or infused at effective levels across one or both sides of at least one textile layer within the side panel 20 so as to provide substantial flammability resistance. The flame retardant composition may be applied in either a continuous or patterned manner although a continuous application may be preferred. Of course, it is contemplated that the side panel 20 may also include other constituents in a layered arrangement including foam backings and the like as will be well known. Thus, it is contemplated that the layer of fibrous textile treated with the intumescent flame retardant composition may be a layer forming the outer decorative surface and/or a layer disposed below the outer decorative surface.

By way of example only, and not limitation one structure of a side panel 20 of multi-layer quilted construction is illustrated in FIG. 1A. As will be appreciated, for purposes of description various components are illustrated with enhanced dimensions and thus are not necessarily in scale relative to one another. As previously indicated, the side panel 20 may be disposed across one or more side surfaces of the mattress 12. The illustrated exemplary side panel includes a surface fabric 22 such as a woven or knitted fabric defining the exterior show surface at the sides of the mattress 12. A backing fabric 24 of woven, knit or nonwoven fabric is disposed in underlying relation to the surface fabric with the spaces between the surface fabric 22 and the backing fabric 24 filled by a high loft fibrous textile material 23. An optional layer of foam 26 may be disposed below the textile layers if desired. In the illustrated construction a pattern of quilting yarns 27 extends through the various layers so as to provide a potentially desirable pattern of undulations across the outer surface. Of course, one or more intervening layers may be disposed above and/or below the backing fabric 24 if desired. By way of example only, and not limitation, such intervening layers or spacers may include woven or nonwoven fibrous textiles and the like.

It is to be understood that the present invention is in no way limited to a particular construction of the side panel 20. Thus, it is contemplated that any of the layers beneath the surface fabric 22 may be eliminated or placed in different positions relative to one another. By way of example only, it is contemplated that any of the backing fabric 24, foam 26, or high loft fiber 23 may be eliminated or placed in different orders relative to one another. Thus, it is contemplated that the side panel 20 may be formed exclusively from a suitable surface fabric 22 alone or in combination with a backing fabric 24 and/or in combination with other textile or non-textile layers. One or more layers of adhesive may also be used in place of the quilting yarns 27 if desired so as to yield a substantially flat surface profile rather than the undulating surface profile illustrated.

Regardless of the actual construction used, the side panel will include at least one discrete or composite fibrous textile layer treated with an intumescent flame retardant composition. In this regard it is to be understood that by “fibrous textile layer” is meant at least one layer of woven, knit or non-woven construction formed from textile fibers. It is contemplated that the intumescent flame retardant composition may be coated or infused at effective levels across one or both sides so as to provide substantial flammability resistance. It is believed that textile layers having at least about 50% by weight (more preferably at least about 70% by weight) of cotton or other cellulosic fiber content may be particularly desirable due to the enhanced flame resistance which can be achieved in such materials. However, a degree of benefit is also provided in textile materials with lower cellulosic fiber content including textile materials formed substantially or completely of polymeric fibers such as polyester and like.

The layer or layers of fibrous textile treated with an intumescent flame retardant composition are preferably disposed near the outer surface of the side panel structure so as to provide early interference with flame propagation from burning bed clothes, dropped cigarettes and the like. Thus, a treated surface fabric 22 and/or backing fabric 24 disposed in the relative positions illustrated in FIG. 1A may be particularly desirable for some constructions.

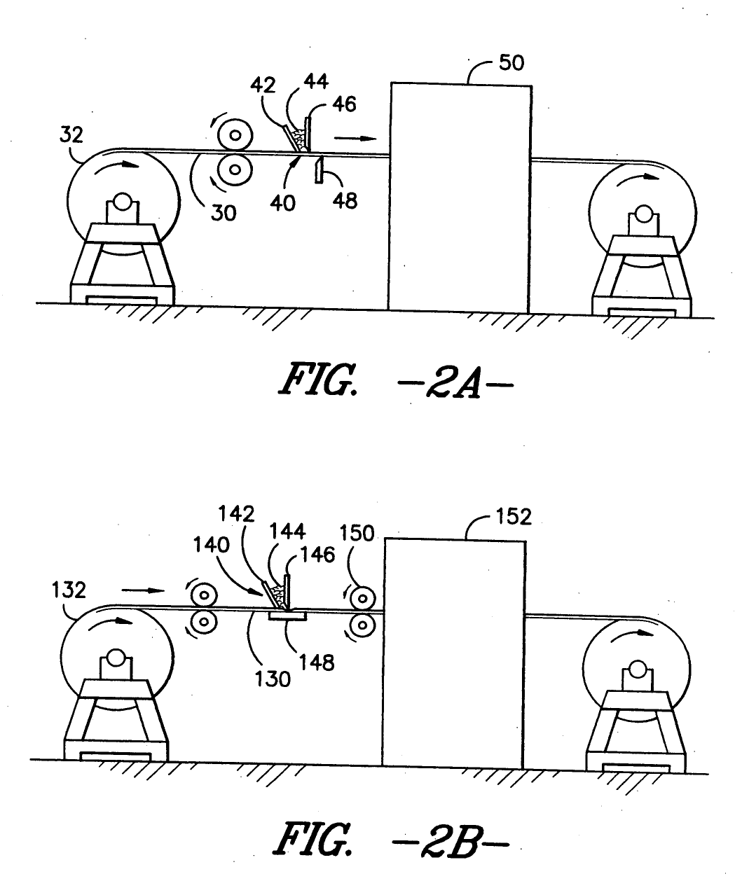

One exemplary arrangement for applying a topical coating across one side of a textile substrate is illustrated in FIG. 2A. As shown, according to this practice a substrate material 30 such as a woven, knit, or non-woven textile to be formed into one of the fibrous layers of a side panel is conveyed from a roll 32 or other supply source to a treatment application station 40. By way of example only, and not limitation, in the illustrated practice the treatment application station includes a deposit reservoir 42 holding a fluid flame retardant composition 44 of intumescent character as will be described more fully hereinafter. At the outlet of the reservoir 42 a knife blade 46 doctors the deposited flame retardant composition to a desired coating weight. A downstream tension bar 48 supports the substrate in tension beneath the knife blade 46 thus giving rise to a so called “knife over air” coating arrangement. The fabric with the applied flame retardant composition is then transferred to an oven 50 maintained at a temperature of about 300° F. for drying and curing. Using this process the flame retardant composition preferably has a viscosity of about 3,000 centipoise or greater such that a defined topical coating is formed. The weight of the applied flame retardant composition is preferably in the range of about 2.0 oz./yd² to about 15.0 oz./yd² (more preferably about 2.0 oz./yd² to about 8.0 oz./yd²) after drying and curing.

In FIG. 2B there is illustrated a coating line for surface infusion of a flame retardant composition 144 wherein the flame retardant composition is forced into the interior of a substrate material 130. Such infusion is believed to be most suitable for impregnation of flame retardant compositions having a viscosity of about 2000 centipoise or less into a substrate material 130 such as a porous woven, knit or non-woven fabric. However, higher viscosities may be used in the event that the substrate material is suitably porous. As illustrated, in such a coating line the substrate material 130 is passed from a supply roll 132 into surface contacting relation with an accumulated mass of the flame retardant composition 144 held at an application station upstream of a knife blade 146. A support plate 148 is disposed below the substrate 114 such that the knife blade 146 and the support plate 148 form a pinch point of defined thickness for passage of the substrate material 130. The thickness of the pinch point is preferably such that a controlled amount of the flame retardant composition 144 is forced into the interior of the substrate material 130. This results in an infused zone of flame retardant composition below the surface of the substrate 130 with a relatively thin film of the flame retardant composition 144 at the surface. The infused zone of flame retardant composition 144 may extend partially or completely across the thickness of the substrate material 130. The substrate material 130 with applied flame retardant composition is then passed through an oven 150 maintained at about 300° F. for drying and curing. The weight of the applied flame retardant composition is preferably in the range of about 2.0 oz./yd² to about 15.0 oz./yd² after drying and curing.

Of course, it is to be understood that any number of other application processes as may be known to those of skill in the art may also be utilized to apply the flame retardant composition to a fabric substrate. By way of example only, and not limitation, such application techniques include direct roll coaters, reverse roller coaters, spray coaters, knife coaters, saturation coaters, rotary screen coaters, curtain coaters, manifold deposit coaters, and the like. In the event that the flame retardant composition is to be applied to both sides of a textile substrate, it is contemplated that a so called dip and nip application unit may be utilized in which the substrate is passed though a bath of the composition to be applied followed by a nip roll to force infusion on both sides.

It will be understood that the viscosity of the flame retardant composition will greatly affect the degree of infusion into a given fabric substrate. By way of example only, for compositions incorporating a latex binder it is contemplated that viscosities greater than about 3000 (preferably about 3,000 to about 5,000) centipoise will tend to form a relatively stable discrete surface layer across the majority of woven textile substrates. Viscosities of less than about 2000 (preferably about 1,000 to about 2,000) centipoise will tend to migrate into a porous textile substrate by applied force, saturation, and/or capillary action to form an infused deposit extending into the substrate at a depth below the initial contact surface with only a light film remaining at the contact surface. Viscosities between about 2,000 and 3,000 centipoise will give rise to an intermediate level of infusion. Viscosities up to 20,000 centipoise or even greater may be desirable for certain specific applications.

As previously indicated, the coated or infused flame retardant composition is of so called “intumescent” character such that it undergoes a swelling and charring when exposed to a flame in a manner as will be described further hereinafter. By way of example only, and not limitation, the flame retardant composition preferably includes a polymer binder such as a latex acrylic co-polymer emulsion and an intumescent composition intermixed with the polymer binder as well as dispersants and/or thickeners as desired to achieve desired physical characteristics to promote coating.

The potentially preferred intumescent compositions for use according to the present invention preferably incorporate the following basic constituents: (i) a phosphorous-releasing catalyst: (ii) a carbon donor: (iii) a blowing agent: and (iv) a halogen donor in the form of a liquid phase oil. It is contemplated that the composition may also include various binders, dispersants and thickeners as may be desired to promote processing and application.

As will be appreciated, it is contemplated that the actual constituents may be selected from a relatively wide range of alternatives. In this regard, exemplarily contemplated phosphorous-releasing catalysts may include mono-ammonium polyphosphate, diammonium polyphosphate, phosophated alcohols, phosophated glycols, potassium tripolyphosphate or combinations thereof. In the event that the treated article is to be subjected to laundering such as in a light weight mattress for a cot, child's bed or the like, the phosphorous-releasing catalyst will-preferably be substantially insoluble in water thereby reducing degradation effects from cleaning. In this regard, mono-ammonium polyphosphate may be particularly preferred for such applications.

In the potentially preferred embodiments of the present invention, the carbon source is preferably pentaerythritol, dipentaerythritol (DPE), or a combination thereof. Such materials give rise to bridging between voids formed by gas evolution during the flame-activated intumescent reaction.

The blowing agent is preferably melamine, urea, dicyandiamide or combinations thereof. However, virtually any other suitable blowing agent may likewise be used.

As previously indicated, according to one potentially preferred practice, the halogen donor in the intumescent compositions of the present invention is preferably in the form of liquid halogenated oil. Such materials are preferably present at levels in the range of about 3 to about 20 percent by weight of the finished composition. Potentially desirable halogenated oils are characterized by exhibiting a liquid phase consistency with a viscosity of not greater than about 30,000 centipoise at room temperature (72 degrees F.). Chlorinated paraffin oils may be particularly preferred. However, for some applications fluorinated or other halogenated oils may also be utilized alone or in combination with one another and/or in combination with chlorinated oils if desired. It is believed that the halogenated oils act as a plasticizer within a latex or other binder thereby softening the final composition after application to or infusion into an article to be protected. Thus, the final article is not stiffened to an excessive degree.

The invention may be further understood through reference to the following non-limiting examples:

### EXAMPLE 1

A flame retardant composition having a room temperature viscosity in the range of about 3,000 centipoise to about 5,000 centipoise was produced from the constituents as set forth in Table 1 wherein all percentages are by weight.

TABLE 1
Standard Viscosity Composition

| ITEM | PERCENT (%) |
|---|---|
| PREMIX | |
| Water | 28.877 |
| Naphthalene Sulfonate | 0.8 |
| Polyoxyethylene Tridecyl Alcohol | 0.72 |
| Ammonium Casein | 4.28 |
| Surfactant | 1.4 |
| Melamine | 8.1 |
| Mono-Ammonium Polyphosphate | 20.21 |
| Pentaerythritol | 8.1 |
| Zinc Borate | 5.69 |
| Antimony Oxide | 5.21 |
| Urea | 0.8 |
| Sulfonated 2 Ethyl Hexanol, 60% | 0.27 |
| Triethanolamine | 0.68 |
| Aluminum Trihydrate | 12.19 |
| Karaya Gum Solution, 5% | 2.67 |
| TOTAL | 100 |
| FINISHED FORMULA | |
| Premix from above | 68.36 |
| Acrylic Latex | 19.27 |
| Water | 3.04 |
| Chlorinated Paraffin oil | 8.88 |
| Aqua Ammonia | 0.29 |
| Final Thickener | 0.16 |
| TOTAL | 100 |

According to the practice utilized, the constituents forming a premix were blended in an attritor to effect both blending and particle size reduction until all solids were below about 150 microns. As will be appreciated, the premix contained a carbon donor in the form of pentaerythritol as well as a blowing agent in the form of melamine in combination with urea. Various constituents were also added to aid in processing and to enhance the suitability for substrate application. In particular, naphthalene sulfonate was added as a dispersant. Polyoxyethylene tridecyl alcohol with 6 mole equivalents of ethoxilation was added as a wetting agent. Ammonium Casein was added as a thickener to enhance body and retain solid additives in suspension so as to promote enhanced shelf life. The surfactant utilized was supplied by Air Products Corporation under the trade designation Surfynol CT-131. Zinc Borate and Antimony Oxide were added to enhance resistance to post-combustion after glow and to enhance resistance to vertical burning respectively. Sulfonated 2 Ethyl Hexanol was added to aid in fluidity. Triethanolamine is a base used to control pH and to aid in stability. The Aluminum Trihydrate is believed to reduce surface tack while also promoting flame resistance by releasing water when subjected to heat. Finally, The Karaya Gum Solution was added as a thickener. Of course, it is to be understood that the actual additives and amounts may be subject to a wide range of variations depending upon the desired character and processing conditions. By way of example, it is contemplated that the Zinc Borate and/or Antimony Oxide may be eliminated if post-combustion after glow and enhanced resistance to vertical burning is not of substantial concern in the contemplated environment of use.

Following formation of the premix in the attritor the premix was thereafter intermixed with a latex carrier or binder. One potentially preferred latex binder is a low T_{g} acrylic latex available from Adhesive Coatings Technologies in Dalton, Ga. under the trade designation BSD-315. It is also contemplated that other binder materials such as vinyl acetate-ethylene copolymers and the like may be utilized if desired. A halogen donating chlorinated paraffin oil was added during the mixing process. By way of example only, and not limitation, one such chlorinated paraffin oil which is believed to be particularly suitable is marketed under the trade designation KLORO 6001 by Dover Chemical Corporation. Finally, in order to achieve the desired viscosity, aqua ammonia was added to raise the pH to above about 8.0 followed by addition of a long chain acid thickener such as Drewtix 53-L marketed by Drew Chemical which is activated at the pH levels realized through the addition of the aqua ammonia.

The resultant composition was characterized by a viscosity in the range of about 3,000 to about 5,000 centipoise and was suitable for application to substrates using standard coating techniques including knife coaters, roll coaters and the like as well as by standard saturation techniques such as pan saturation and so called “dip and nip” application in which a substrate is passed through a bath and then through a compressive nip roll. If desired, higher viscosities up to about 20,000 centipoise may be achieved by increasing the amount of thickener.

### EXAMPLE 2

A low viscosity flame retardant composition characterized by a room temperature viscosity of about 1,000 to about 2,000 centipoise was produced utilizing the formulation as set forth in Table 2.

TABLE 2
Low Viscosity Composition

| ITEM | PERCENT (%) |
|---|---|
| PREMIX | |
| Water | 28.877 |
| Naphthalene Sulfonate | 0.8 |
| Polyoxyethylene Tridecyl Alcohol | 0.72 |
| Ammonium Casein | 4.28 |
| Surfactant | 1.4 |
| Melamine | 8.1 |
| Mono-Ammonium Polyphosphate | 20.21 |
| Pentaerythritol | 8.1 |
| Zinc Borate | 5.69 |
| Antimony Oxide | 5.21 |
| Urea | 0.8 |
| Sulfonated 2 Ethyl Hexanol, 60% | 0.27 |
| Triethanolamine | 0.68 |
| Aluminum Trihydrate | 12.19 |
| Karaya Gum Solution, 5% | 2.67 |
| TOTAL | 100 |
| FINISHED FORMULA | |
| Premix from above | 70.55 |
| Chlorinated Paraffin Oil | 9.2 |
| Acrylic Latex | 19.95 |
| Aqua Ammonia | 0.3 |
| TOTAL | 100 |

As can be seen, the premix in the low viscosity composition is identical to the premix for the higher viscosity composition previously described. Likewise, the processing techniques are also identical. However, in preparation of the finished formula the thickener is eliminated thus yielding a much lower viscosity product which may be more suitable for applications such as infusion into the upper surface of a textile to achieve saturation or wherein penetration is at least partially dependant upon capillary action and/or physically forcing the flame retardant composition into the article to be protected.

### Performance Evaluation

The composition of Example 1 was deposited across a greige plain woven fabric having a weight of about 3 ounces per square yard at a coating weight of about 4.5 ounces per square yard using a knife over air coater. The warp yarns in the fabric were a blend of 50% cotton and 50% polyester while the fill yarns were 100% cotton thereby yielding an overall fabric blend of 70% cotton and 30% polyester. No scouring, bleaching, or framing of the base fabric was done prior to coating. The coated fabric was then dried at a temperature of about 300° F. to cure the binder. Various physical characteristics for the resultant fabric were measured as set forth below.

Stiffness

The base fabric (without the coating) and the coated fabric were then measured for stiffness in accordance with ASTM D 1388, Standard Test Method for Stiffness of Fabrics, Option A, Cantilever Test. This test employs the principle of cantilever bending of the fabric under its own mass. The cantilever test is conducted by sliding the specimen at a specified rate in a direction parallel to its long dimension, until its leading edge projects from the edge of a horizontal surface. The length of the overhang is measured when the tip of the specimen is depressed under its own mass to the point where the line joining the top to the edge of the platform makes a 41.5 degree angle with the horizontal. From this measured length, the bending length and flexural rigidity are calculated.

For the ASTM D 1388 Cantilever Test, four specimens each in the warp and fill direction of the woven fabric, coated and uncoated, were tested. The test results indicated that the average bending length of the coated specimens was 36 percent lower than that of the uncoated greige fabric when averaged for warp and fill directions. Flexural rigidity was reported for the coated sample at 27 percent less than for the uncoated greige fabric when averaged for warp and fill directions. The test data thus shows that the present invention does not contribute to increased stiffness when coating under the described conditions and tested in accordance with ASTM D 1388. This reflects suitability for use in a mattress environment.

Tensile Strength

The material described herein was tested according to national standard ASTM D751, Procedure A Grab test method. The Grab test is conducted using specimens 100 mm in width×150 mm in length. A total of ten specimens are tested, five in the lengthwise orientation and five in the crosswise direction. An Instron or other similar machine designed to measure force is utilized, with the sample situated between clamping jaws and subjected to increasing strain until the specimen fails. The force required to break the specimen is recorded both graphically and numerically. The tested fabric exhibited a minimum tensile strength of 90 lbs/ft in the warp (length) direction and 45 lbs/ft in the fill (width) direction. Such levels indicate suitability for use in a mattress environment.

Burst Strength

To determine suitability for use in a covering panel, specimens of the coated fabric were tested for resistance to puncture by blunt objects. National standard ASTM D751 specifies a test method for bursting strength utilizing a 44 mm diameter ring clamp mechanism applying pressure against a polished steel ball of 25 mm in diameter until the material is ruptured. A strain-generating and force measuring machine such as an Instron or other known laboratory device is used to conduct the burst testing. The coated fabric described above has been found to generate minimum burst strength values of at least 70 lbs/in. Such levels are consistent with suitability for use in a mattress environment.

Hydrostatic Resistance

In certain instances it has been found desirable for fabrics used in mattress environments to be resistant to penetration by liquids. One test used to demonstrate such liquid resistance may be found in ASTM D751, Hydrostatic Resistance: Rising Water Column Tester Procedure 2. In this test, the test specimens of at least 200 mm square are held by a clamping ring with measurements of 170 mm outside diameter and 115 inside diameter. A minimum of five specimens are tested. The ring is sealed with a rubber gasket material. A mirror is situated under the clamp for the observation of any leakage by the specimen. An inlet tube for the introduction of water and a vent opening are present. A steel scale graduated in millimeters is affixed to the water column tube. The test is conducted by introducing water to a defined level, then examining the sample for leakage. When tested as per the specified method, coated fabrics as described above have been found to have an applied pressure of greater than 50 cubic centimeters prior to leakage. Such levels are consistent with suitability for a mattress environment:

Seam Strength

In the manufacture of mattress panels, seam strength is important for maintaining the integrity of the sewn covering. One test which may be used to demonstrate this strength is ASTM D751, Seam Strength. The test is conducted by preparing three individual test specimens 50 mm in width×200 mm in length, with a sewn seam horizontally in the center of each specimen. A testing machine known to those familiar with the trade is the Instron, but other similar devices for inducing, measuring and recording strain force may be used. The specimens are tested individually by placing each end in the machine, clamping jaws and starting the machine. The test is run until the specimen ruptures. The force required to rupture the material is recorded, as is whether the rupture occurred at the seam or within the fabric of the specimen.

When tested in accordance with this procedure, coated fabrics as described above were characterized a minimum seam strength of greater than 55 lbs/ft. Such levels are consistent with suitability for a mattress environment.

Abrasion Resistance

Flame barrier materials used in the construction of mattress panels must maintain their flame resistance even after consumer usage. One measure of maintenance of this integrity is abrasion resistance as measured by ASTM Test Method D4157 Oscillatory Cylinder Method. Values from this testing are reported on a scale from one to five, with one representing negligible or no wear and five representing substantial wear. The test is conducted using a specialized machine detailed in the procedure, described as an oscillatory abrasive machine. The device is outfitted with clamps which facilitate mounting of an abrasive material, which for this test is a #10 cotton duck fabric. The machine additionally has specimen holding arms for retention of the test specimens, equipped with a mechanism to draw each specimen tight for the test procedure. The machine is fitted with a calibrated mass of 150 g attached to each pressure pad, and an automatic cycle counter. A cycle is defined as one complete back and forth motion of the oscillatory head.

A minimum of twelve specimens are tested, six each in warp and fill directions. The specimens are prepared to a dimension of 73 mm×245 mm, cut in the appropriate direction to test warp and fill directions. The specimens must be free of wrinkles or folds, and must be cut a minimum of 10 percent of the distance to the selvedge. The test is begun, and the samples are inspected at intervals of three thousand cycles. The test may be run until the material fails or for a predetermined number of cycles. In this instance, the test was stopped upon completion of 15,000 cycles.

When tested in accordance with this method, the coated fabric as described above was measured at a value of 1 after 15,000 cycles thereby indicating negligible wear.

Blocking Resistance

Coated fabrics may sometimes exhibit a tendency to block, a condition in which the coating sticks to another surface, either the back of the coated fabric or the coated surface itself. When blocking occurs, the coating will peel away when separating the two surfaces. One test method for the measurement of blocking is ASTM D751, Determination of Blocking Resistance of Fabrics Coated with Rubber or Plastics at Elevated Temperatures. The test procedure consists of using two glass plates, measuring 100 mm×100 mm×3 mm thick, with 200 mm×200 mm specimens folded double, face to face then back to back, placed between the glass plates. A calibrated 1.8 kg mass is placed on the top plate centrally to apply even pressure. The test assembly is placed in an oven at a temperature of 70 degrees centigrade for a period of six hours. Upon completion of the oven time, the specimen is immediately removed from the glass plates and allowed to cool for a minimum of five minutes in the folded state. After the cooling, the specimen is unfolded carefully and evaluated for resistance using the scale of 1=No blocking—cloth surfaces separate without any evidence of blocking, 2=Slight blocking—cloth surfaces must be slightly peeled to separate, 3=Blocking—cloth surfaces separate with difficulty or coating is removed during separation.

When tested in accordance with the prescribed procedure, the coated fabric as described above exhibited no blocking, and a rating of 1 on the prescribed testing scale.

Toxicity

When tested for toxicity, fabrics with applied coating as described above were shown to be non-toxic. Testing was done in accordance with test method P203 UDP, as administered by Product Safety Laboratories, in which laboratory rats ingested 5,000 milligram of the coated fabric per kilogram of body weight and were subsequently observed for a fourteen day period. At the end of the test period, the three animals tested were each active and healthy, and had actually gained weight during the test period. There were no signs of gross toxicity, adverse pharmacologic effects or abnormal behavior.

Skin Irritation

Coated fabrics in accordance with the present invention as described above have been found through laboratory studies to be non-irritating to skin. Other materials designed to satisfy mattress flammability requirements, such as fiberglass and some chemical treatments, are known skin irritants.

One test method used to determine skin irritation evaluates the irritation of test specimens upon the skin of live rabbits. To conduct the test, three rabbits are prepared by clipping away the hair from the dorsal area of each animal's trunk. A one inch square of the test substance is moistened with distilled water, then applied directly to the animal skin and covered with a one inch square 4-ply gauze pad. The specimen is then secured to the rabbit by wrapping the entire trunk with micropore tape. An Elizabethan collar is placed on each rabbit to prevent removal of the specimen by the animal. The sample remains on each animal for a four-hour period after which the specimen, gauze, tape, and the Elizabethan collar are removed. The rabbit is evaluated and data recorded at one, twenty four, forty eight, and seventy two hour intervals. The Primary Dermal Irritation Index is scored as follows:

| PDII | Classification |
|---|---|
| <0.5 | Non-Irritating |
| 0.5-2.0 | Slightly Irritating |
| 2.1-5.0 | Moderately Irritating |
| >5.0 | Severely Irritating |

Coated fabrics in accordance with the present application as described above were shown to have a Primary Dermal Irritation Index (PDII) of 0.0.
Flame Resistance:

Specimens of the coated and uncoated fabrics as described above were subjected to flame tests in which the samples were exposed to a large open flame presented by a propane-fueled burner with multiple orifices, simulating the NIST (National Institute for Standards Technology) burner apparatus utilized in the large-scale mattress flammability testing as set forth in Technical Bulletin 603 as previously described. The coated fabric did not burn after an exposure time of 50 seconds while the uncoated fabric exhibited vigorous combustion.

In addition to the standards set forth in Technical Bulletin 603, this material has additionally been proven to satisfy the so-called “Crib 5” flammability standard applicable to furniture as set forth in British Standard 5852 (incorporated herein by reference). As will be well known to those of skill in the art, this standard sets forth test methods for assessing the ignitability of upholstered composites for seating covers and fillings when subjected to flaming sources of various thermal output ranges. More particularly, this standard test method utilizes a frame supporting segments of the material to be tested in an arrangement corresponding to the intersection between the seat and the back of a chair. A crib assembly formed from seasoned planks of softwood is constructed in a predefined manner including a layer of flammable lint and is thereafter ignited at an interior position on the seat in contact with the back. If flaming or progressive smoldering is not observed, the test is repeated at a different location. If flaming or progressive smoldering is still not observed, the material is considered to pass the test criteria. In this regard, any composite that produces externally detectable amounts of smoke, heat or glowing 60 minutes after ignition of the crib is considered to display progressive smoldering. Different crib constructions are utilized to mimic different levels of ignition. In the so called “crib 5” test the crib is formed from 10 layers (each of two sticks) for a total of 20 sticks wherein the sticks are 40±2 mm in length with a square section of 6.5 mm+0.5 mm. The total mass of sticks is 17 grams+1 gram. The approximate dimensions are 40 mm×40 mm. Specimens of the cotton polyester fabrics as described above coated via knife, roller, and saturation coater have successfully met the criteria of this test, while uncoated fabrics burned readily.

It is contemplated that the mattress side panels of the present invention may find application in environments such as recreational vehicles and the like wherein flammability standards applicable to automotive vehicles must be met. As will be appreciated by those of skill in the art, in Federal Motor Vehicle Safety Standard 302 (incorporated by reference) a flame is applied to a hanging strip of material in a controlled environment. The length of the material, which bums prior to self extinguishment and the time required for self extinguishment, are measured. Specimens of the cotton polyester fabrics as described above coated via knife, roller, and saturation coater have successfully met the criteria of this test, while uncoated fabrics burned readily.

It is also contemplated that the mattress side panels of the present invention may find application in environments such as sleeper sofas and the like wherein flammability standards applicable to seating furniture must be met. In California Department of Consumer Affairs Bureau of Home Furnishings and Thermal Insulation Technical Bulletin 133 (incorporated by reference) furniture combustion characteristics are measured in a so called “burn room” provided with instrumentation to monitor temperature, CO concentration, smoke opacity and sample, weight loss. The test sample is actual seating furniture or a mock up of such furniture and includes the fabrics, filling materials and combustible decorative parts of such furniture. Flame is introduced into the burn room for 80 seconds through a square gas burner of defined construction intended to emulate an engulfing fire. Following ignition, combustion is allowed to continue until all combustion has ceased or 1 hour of testing has elapsed or flameover or flashover appears inevitable. Seating furniture fails if temperature increases exceed certain predefined levels, if opacity levels exceed certain predefined levels, if carbon monoxide concentration exceeds certain predefined levels, if furniture weight loss exceeds certain predefined levels or if heat release exceeds maximum instantaneous or cumulative levels. Specimens of the cotton polyester fabrics as described above coated via knife, roller, and saturation coater exposed to flame conditions simulating this test did not burn, while uncoated fabrics burned readily.

It is also contemplated that the mattress side panels of the present invention may find application in furniture such as futons and the like. California Technical Bulletin 117, Draft dated 2/2002, Section 1 defines a method for testing open-flame resistance of Upholstered Furniture. This method is designed to determine the resistance of upholstery cover fabrics to flame propagation when tested with a small open flame. In the test, a seat piece and back piece are constructed using the actual cover fabric, fire barrier material, over a standard flame-retardant foam pad. The weight loss and burn time is recorded.

A butane fueled burner tube, measuring 200 mm in length, 8 mm outside diameter, and 6.5 mm inside diameter is connected via an 8-10 foot length of 7 mm clear flexible tubing. The pressure to the burner is regulated via a cylinder regulator at 2.8 kPa, and at a flow rate of 45 ml/min at 23° C., producing a flame height of approximately 35 mm. The burner is placed directly in the crevice between the seat and back pieces, and ignited for 20 seconds.

The treated fabrics also have been shown to pass National Fire Protection Association test 701, entitled “Flame Propagation of Textiles and Films” which consists of two test methods. For the testing of the fabric as described above, Test Method 1 is applicable. The purpose of this test method is to assess the flame propagation of flame beyond the area exposed to the ignition source.

To conduct the test, a specimen measuring 150 mm wide×400 mm in length is vertically suspended in the prescribed testing chamber. Methane gas, at a pressure of 17.5 kPa and a flow rate of 1205 ml/min, and an airflow rate of 895 ml/min, supply a Meeker (or Fisher) tapered laboratory burner with grid-top adjustable channels. The flame height is 100 mm with the burner in the vertical position. The testing is conducted with the burner positioned horizontally, 25 mm from the face of the specimen and with the center axis of the burner horizontal and perpendicular to the bottom center of the specimen.

The burner is ignited for a time of 45 seconds. After the 45 second exposure, any after flame time of the specimen is recorded, as well as characteristics of the smoke produced, vigorousness of burning and dripping of molten material. The test is repeated for a total of ten specimens.

The test is passed if:

1. Fragments or residues of specimens that fall to the floor of the test chamber do not burn for an average exceeding 2 seconds per specimen.

2. The average weight loss of the 10 specimens is 40 percent or less.

3. No individual specimen's weight loss deviates more than 3 standard deviations from the mean of the ten specimens.

Specimens of the woven fabric as described above coated via a saturation coater have successfully met the criteria of this test, while uncoated fabrics burned readily.

### COMPARATIVE EXAMPLES

The character of pliable textile substrates treated with intumescent flame retardant compositions as described above in accordance with the present invention was compared relative to a pliable textile substrate treated with an alternative intumescent flame retardant composition. The textile substrate treated with the alternative intumescent flame retardant composition was a sample of a commercial product currently being marketed by the company that is believed to own rights to U.S. patent application 2003/0082972A1 to Montfalcone, III for use in providing flame resistance within mattress environments. Thus, the sample incorporating the alternative flame retardant composition is marketed by an entity familiar with intumescent coating options. Moreover, since the sample is of an actual commercial product, it is believed that the product has likely been the subject of optimization efforts intended to produce desirable tactile and stiffness characteristics for use in a mattress and which would not use unnecessarily excessive levels of coating compositions. As best understood, the product is intended for use at a position below the mattress surface in overlying relation to a foam backing. The textile substrate appeared to be a warp knit fabric provided with a coating having intermittent pinhole voids across the surface, although specific construction details could not be determined with certainty.

For purposes of comparison, a pliable textile sample of greige plain woven fabric as described in Example 1 above having a weight of about 3 ounces per square yard was coated with an intumescent flame retardant composition at a coating weight of about 4.5 ounces per square yard using a knife coater. As previously indicated, the fabric had a construction of 78 warp yarns per inch×54 fill yarns per inch. The warp yarns were 100% cotton with a yarn count of 35/1. The fill yarns were 50% polyester, 50% cotton with a yarn count of 35/1. The flame retardant composition was as described in Example 1 above. No scouring, bleaching, or framing of the base fabric was done prior to coating. The coated fabric was then dried at a temperature of about 300° F. to cure the binder. As indicated in Example 1 above, such coated fabric exhibited flame resistance characteristics such that samples did not burn after an exposure time of 50 seconds when exposed to a large open flame presented by a propane-fueled burner with multiple orifices simulating the burner apparatus utilized in the large-scale mattress flammability testing as set forth in California Department of Consumer Affairs Bureau of Home Furnishings and Thermal Insulation Technical Bulletin 603.

For purposes of further comparison, a pliable textile sample of circular knit fabric having a weight of about 3.3 ounces per square yard was coated with an intumescent flame retardant composition at a coating weight of about 5 ounces per square yard using a knife coater. The fabric had a terry knit pattern construction with 17 wales per inch by 24 courses per inch. The yarns used were a blend of about 31% cotton and 69% polyester. The flame retardant composition was as described in Example 1 above. No scouring, bleaching, or framing of the base fabric was done prior to coating. The coated fabric was then dried at a temperature of about 300° F. to cure the binder. Such coated fabric exhibited flame resistance characteristics such that samples did not burn after an exposure time of 50 seconds when exposed to a large open flame presented by a propane-fueled burner with multiple orifices simulating the burner apparatus utilized in the large-scale mattress flammability testing as set forth in California department of consumer affairs Bureau of Home Furnishings and Thermal. Insulation Technical Bulletin 603.

In order to evaluate the character of the coated substrates in terms of tactile feel or “hand” and flexibility, equal area samples of the woven fabric and the knit fabric as described above coated with the intumescent flame retardant composition of Example 1 at the identified levels were submitted to a panel of four persons (two male and two female) with no knowledge of intumescent coating compositions along with an equal area sample of the alternative commercial mattress protective textile coated with the alternative intumescent composition. All three samples were unmarked. The panel members were asked to assign comparative rankings to the samples relative to one another for flexibility and feel. Available choices for the comparative rankings were “Much Worse”, “Worse”, “Same As”, “Better“; and “Much Better”. The panel members were all non-management employees of a company having rights in the present invention and as such were under a general obligation of confidentiality. None of the panel members had any prior involvement with the present invention. Each of the equal area samples was also weighed to compare the mass per unit area of the products. The results of the evaluation are set forth in Table 3 below. The four comparative rankings correspond to the four panel members. The increase in mass per unit area from the wet coating state is due to natural heat shrinkage during curing.

TABLE 3

| | | FLEXIBILITY | FEEL |
|---|---|---|---|
| | | Relative to | Relative to |
| | MASS PER | Current | Current |
| SAMPLE | Unit Area | Commercial | Commercial |
| Current | 8.4 oz/yd2 | Baseline | Baseline |
| Commercial | | | |
| Product | | | |
| Woven | 8.4 oz/yd2 | Much Better | Much Better |
| Substrate | | Much Better | Much Better |
| | | Worse | Worse |
| | | Better | Better |
| Knit Substrate | 8.5 oz/yd2 | Much Better | Much Better |
| | | Much Better | Much Better |
| | | Much Better | Much Better |
| | | Much Better | Much Better |

These results indicate that textile substrates coated with the intumescent flame retardant compositions as described herein at levels effective to provide flame protection suitable to pass mattress flammability standards are recognized as being more flexible and with better feel than known alternative commercial intumescent coated materials. The results indicate that knit substrates may be particularly desirable relative to the commercial alternative product.

While the present invention has been illustrated and described in relation to certain potentially preferred embodiments and practices, it is to be understood that such embodiments and practices are illustrative and exemplary only and that the present invention is in no event to be limited thereto. Rather, it is contemplated that modifications and variations to the present invention will no doubt occur to those of skill in the art upon reading the above description and/or through a practice of the invention. It is therefore contemplated and intended that the present invention shall extend to all such modifications and variations which incorporate the broad principles of the present invention within the full spirit and scope thereof.

1. A mattress comprising a mattress panel structure adapted for covering a mattress core to define a mattress side surface, the mattress panel structure comprising: at least one pliable fibrous textile layer having a flame retardant composition of intumescent character disposed in coated or infused relation across said at least one fibrous textile layer to increase flammability resistance of said at least one fibrous textile layer, wherein the flame retardant composition is substantially free of bromine and comprises a blend comprising: a phosphorous releasing catalyst; a carbon donor; a blowing agent; and a halogen donor comprising a halogenated paraffin oil within a latex base.

2. The invention as recited in claim 1, wherein the phosphorous releasing catalyst is substantially insoluble in water.

3. The invention as recited in claim 2, wherein the phosphorous releasing catalyst is mono-ammonium polyphosphate.

4. The invention as recited in claim 1, wherein the carbon donor is selected from the group consisting of pentaerythritol, dipentaerythritol and combinations thereof.

5. The invention as recited in claim 1, wherein the blowing agent is selected from the group consisting of melamine, urea, dicyandiamide and combinations thereof.

6. The invention as recited in claim 1, wherein the latex base comprises an acrylic latex.

7. The invention as recited in claim 1, wherein the phosphorous releasing catalyst is mono-ammonium polyphosphate, wherein the carbon donor is selected from the group consisting of pentaerythritol, dipentaerythritol and combinations thereof, and wherein the blowing agent is selected from the group consisting of melamine, urea, dicyandiamide and combinations thereof.

8. The invention as recited in claim 1, wherein the flame retardant composition is characterized by a viscosity of 3,000 to 5,000 centipoise.

9. The invention as recited in claim 1, wherein the halogen donor comprises a chlorinated paraffin oil present at a level in the range of 3 to 20 percent by weight of the flame retardant composition and wherein the chlorinated paraffin oil is characterized by being in a liquid phase and having a viscosity of not greater than 30,000 centipoise at room temperature.

10. A mattress comprising a mattress panel structure adapted for covering a mattress core to define a mattress side surface, the mattress panel structure comprising: at least one pliable fibrous textile layer having a flame retardant composition of intumescent character disposed in coated or infused relation across said at least one fibrous textile layer to increase flammability resistance of said at least one fibrous textile layer, wherein the flame retardant composition is substantially free of bromine and comprises a blend comprising: at least one of the group consisting of zinc borate and antimony oxide in combination with a phosphorous releasing catalyst; a carbon donor; a blowing agent; and a halogen donor in the form of a chlorinated paraffin oil blended within a latex base, wherein the chlorinated paraffin oil is present at a level in the range of 3 to 20 percent by weight of the flame retardant composition, and wherein the chlorinated paraffin oil is characterized by being in a liquid phase and having a viscosity of not greater than 30,000 centipoise at room temperature.

11. The invention as recited in claim 10, wherein the flame retardant composition of intumescent character further comprises Aluminum Trihydrate.

12. The invention as recited in claim 10 wherein the phosphorous releasing catalyst is substantially insoluble in water.

13. The invention as recited in claim 12, wherein the phosphorous releasing catalyst is mono-ammonium polyphosphate.

14. The invention as recited in claim 10, wherein the carbon donor is selected from the group consisting of pentaerythritol, dipentaerythritol and combinations thereof.

15. The invention as recited in claim 10, wherein the blowing agent is selected from the group consisting of melamine, urea, dicyandiamide and combinations thereof.

16. The invention as recited in claim 10, wherein the flame retardant composition is characterized by a viscosity of 3,000 to 5,000 centipoise.

17. A mattress comprising a mattress panel structure adapted for covering a mattress core to define a mattress side surface, the mattress panel structure comprising: a surface fabric defining an outwardly projecting exterior; at least one backing fabric layer disposed at a position below the surface fabric and at least one layer of foam disposed at a position below said at least one backing fabric layer, wherein said at least one backing fabric layer comprises a pliable fibrous textile layer having a flame retardant composition of intumescent character disposed in coated or infused relation across said pliable fibrous textile layer to increase flammability resistance of said pliable fibrous textile layer, wherein the flame retardant composition is substantially free of bromine and comprises a blend comprising: a phosphorous releasing catalyst; a carbon donor; a blowing agent; and a halogen donor within a latex base, wherein the halogen donor comprises a chlorinated paraffin oil present at a level in the range of 3 to 20 percent by weight of the flame retardant composition and wherein the chlorinated paraffin oil is characterized by being in a liquid phase and having a viscosity of not greater than 30,000 centipoise at room temperature.
